(19) United States
(12) Patent Application Publication
(10) Pub. No.: US 2012/0297993 A1
(43) Pub. Date: Nov. 29, 2012

(54) IN-LINE PERFORATING PROCESS AND PERFORATION MATERIAL FOR SAME

(75) Inventors: CHARLES G. JORDAN, West Des Moines, IA (US); WILLILAM C. BENSKIN, Des Moines, IA (US)

(73) Assignee: THE PRINTER, INC., Des Moines, IA (US)

(21) Appl. No.: 13/117,520

(22) Filed: May 27, 2011

(51) Int. Cl. B41F 27/00; B23P 17/04

(52) U.S. Cl. 101/32; 101/382.1; 29/592

(57) ABSTRACT

A method and apparatus for perforating a sheet of paper in an offset printing process is provided. The method includes producing a perf plate, which creates the perforations, by printing an image onto a printing plate. The image is produced by a desktop publishing application. The printed image produces guidelines on the printing plate, to which a selected perf rule is applied. The perf rule is selected according to the style of perforation that is desired for the specific application. The perf rule is attached to the printing plate within the guidelines by an adhesive backing of the perf rule, as well as a layer of tape over the perf rule to ensure the perf rule stays in place.

### FIELD OF THE INVENTION

The present invention generally relates to a perforation process of IOD (inline offset die-cutting) and/or perf jackets, which are used in the offset printing industry. More particularly, but not exclusively, the present invention relates to an in-line perforating process and perforation material for same.

### BACKGROUND OF THE INVENTION

The background of the invention is discussed in the context of offset printing presses and more specifically IOD (inline offset die-cutting) utilized on offset printing presses. Offset printers are very often utilized to produce printed material requiring perforating, cutting or creasing. Printed material may include checks or advertising material such as coupons. A perf jacket or plate creates perforations, cuts or creases on paper as the paper passes over an impression cylinder so that the printed material may be easily separated. Presently, perf jackets and plates are chemically-etched, machined, flexible dies produced by third party manufacturers. The present invention is not to be limited to this specific context.

A large number of printing presses presently use perf jackets. A jacket is attached to an offset press by jacket bars. A specific design is configured and sent to a third party manufacturer, who chemically etches the design onto one or more jackets and who also attach the jacket bars to the jackets. One jacket is needed for smaller project, but two jackets are used together in larger-sized perforating projects, such as when the projects are plate-sized. However, the third-party perf jackets are expensive. The design must be sent to a third party, who then must perform the chemical etching before mailing or returning the finished product. In addition, the price charged for producing the perforated materials is usually less than the cost of producing the perf jacket. Therefore, the cost and amount of time it takes to produce the perf jackets results in lost money by a printing press business.

In newer printing presses using in-line coating units, plates are used instead of the jackets. The plates allow for easy access to the presses, which reduces the set-up time for a printing or perforation process. The plates are made into perf plates for creating perforations or creases in printed materials, similar to the perfjackets. The plates are produced by a third party, similar to perf jackets. The third party chemically etches the design on the plates in a foreign country, which adds to the amount of time it takes to receive a perf plate. However, the cost to produce perf plates is extremely high, and the process generally takes more than four days.

Prior to the plate-making process, digital files are arranged on a computer in such a way as to maximize the use of the sheet of paper being used. This process is called imposition. Digital files must be imaged onto printing plates. Information from digital files is transferred to printing plates in much the same way as digital photographs are imaged. When exposed to light, a chemical reaction occurs that activates an ink-receptive coating on the printing plate. This results in the transfer of the digital image onto the plate. This process is known as the computer-to-plate (CTP) process.

There are different materials for printing plates, including aluminum and polyester. The best plate material is aluminum, which is more costly, but provides the quality and durability necessary to produce high-quality offset printing. Each of the primary process colors: black, blue, red, and yellow have a separate printing plate. This is known as the four-color or CMYK printing process.

As a sheet of paper is fed into the printing press, it will move through a series of rollers and blankets where the ink is transferred onto the paper. A four-color press will have 4 or more printing units which have separate sets of rollers and blankets for each color. As the press sheet moves from one unit to the next, another color will be transferred to the sheet of paper. A perf plate may be used on any of the printing units as needed.

The press sheet is left slightly damp by all of the ink and water being applied to it. At this point in the process, there is a risk of the ink smudging. Smudging is minimized by applying a water-based coating to the press sheets. This coating is called an aqueous coating, and the coating may be either a glossy coating, or a dull coating. Once the coating is applied, the press sheets move through an infra-red dryer. Heat from infra-red radiation is used to quickly dry the ink and coating, so that smudging does not occur.

Each perf plate is made from a similar digital file as used to image each color plate, and indicates the perforation, cuts or crease locations. A few benefits of using each IOD (inline offset die-cutting) perf jacket or perf plate simultaneously on an offset printing press or coater is to print and cut in a single operation at normal press speeds which reduces delivery periods, allows reuse of the flexible dies, and accords optimum flat sheet alignment after finishing.

There are also disadvantages to using IOD (inline offset die-cutting) or perf jackets simultaneously on the sheet-fed printing press or coater. A few disadvantages are the time to manufacture each IOD (inline offset die-cutting), perf jacket or perf plate and the high cost when processing small printing jobs. Also, the IOD (inline offset die-cutting) or perf jacket requires manual alignment by a technician after installation.

What is needed is an apparatus and method for producing an in-line perforation, cutting or creasing device and perforating, cutting or creasing process for same having the advantage of being less expensive and having a shortened time to manufacture.

### BRIEF SUMMARY OF THE INVENTION

Therefore, it is a primary object, feature, and/or advantage of the present invention to improve over the state of the art.

It is another object, feature, and/or advantage of the present invention to provide an improved method for producing a perf jacket for use with offset printing presses.

It is yet another object, feature, and/or advantage of the present invention to provide an improved method of producing a perf jacket that is less expensive and time consuming.

It is a further object, feature, and/or advantage of the present invention to provide a perforation plate which utilizes a standard printing plate.

Another object, feature, and/or advantage of the present invention is to provide a perforation plate which utilizes standard printing plate and that is less expensive to create.

One or more of these and/or other objects, features, or advantages of the present invention will become clear from the specification and claims that follow. No single embodiment need exhibit each and every object, feature, or advantage.

According to one aspect of the present invention, a method of making a perf plate for producing perforations in a sheet of paper in an offset printing press is provided. The method includes creating an image. At least one perf rule guideline is printed on a printing plate according to said image. Finally, a perf rule is applied onto the at least one perf rule guideline.

According to another aspect of the present invention, a method of perforating a sheet of paper in an offset printing press is provided. The method includes producing a perf plate by creating an image in a desktop publishing application, printing the image onto a printing plate to create perf guidelines, and applying at least one perf rule to the perf guidelines. The perf plate is operably attached to a combination plate and blanket cylinder in line of an offset printing press. A sheet of paper is passed through the offset printing press such that the perf plate contacts the sheet of paper to produce perforations therein.

According to yet another aspect of the present invention, a method of making a perf jacket for producing perforations in a sheet of paper in an offset printing press is provided. The method includes creating an image. At least one perf rule guideline is printed on a printing plate according to said image. A perf rule is applied onto the at least one perf rule guideline. Finally, plate bars are attached to opposite ends of the printing plate, the plate bars configured to operatively attach to a blanket cylinder of a printing station of a printing press.

### BRIEF DESCRIPTION OF THE DRAWINGS

FIG. 1 is a representation of a typical offset press configuration.

FIG. 2 is a representation of an IOD (inline offset die-cutting).

FIG. 3 is a representation of a perforation plate with an XY grid.

FIG. 4 is a representation of a standard printing plate.

FIG. 5 is a representation of a standard printing plate after CTP (computer-to-plate) processing.

FIG. 6 is a representation of the present invention utilizing a standard printing plate.

FIG. 7 is a block diagram illustrating the method for producing the preferred embodiment.

FIG. 8 is a representation of a perfjacket.

FIG. 9 is an enlarged section view of the plate and bar of the perf jacket of FIG. 8.

FIG. 10 is a flow chart of the method of making the perfjacket of FIG. 8.

### DETAILED DESCRIPTION OF THE PREFERRED EMBODIMENT

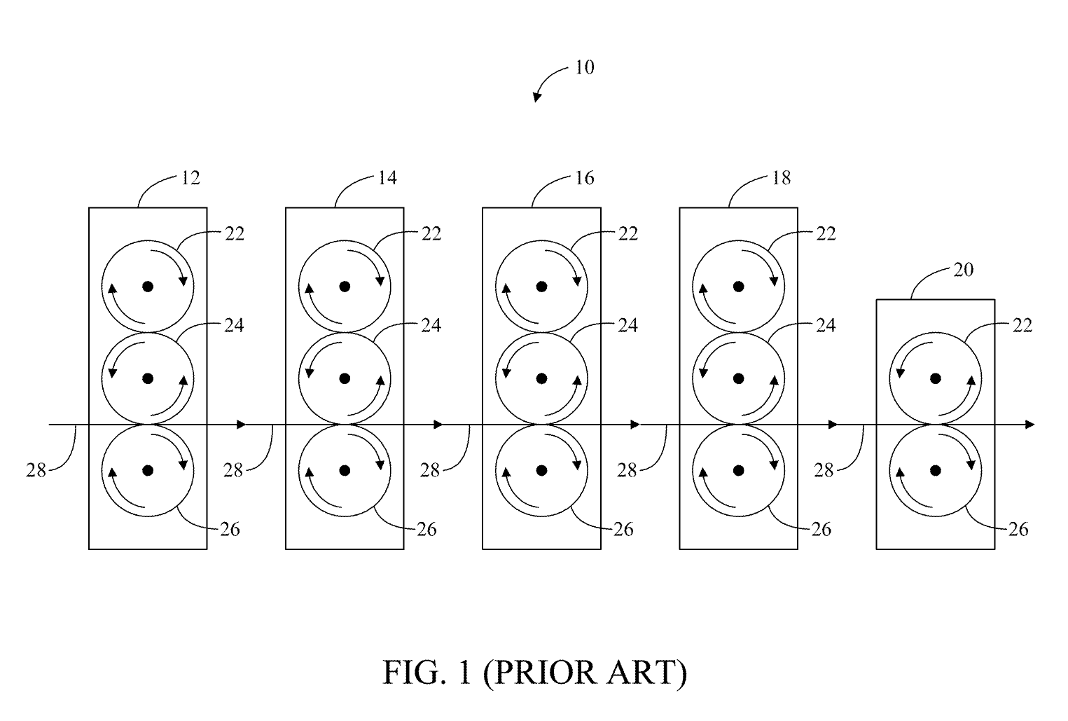

FIG. 1 shows a typical offset printing press system 10 having printing stations 12, 14, 16 and 18, wherein printing station 12 applies black ink, printing station 14 applies blue ink, printing station 16 applies red ink and printing station 18 applies yellow ink. Each printing station includes principally three rotating cylinders: a plate cylinder 22, which carries the printing plate, a blanket cylinder 24, which is covered by a layer of rubber or the like and an impression cylinder 26, which presses the sheet against the blanket cylinder 24. The offset printing press system 10 also has a coater station 20, which includes principally two rotating cylinders: a plate cylinder 22 and an impression cylinder 26. The sheet paper follows a sheet path 28 through the offset printing press system 10.

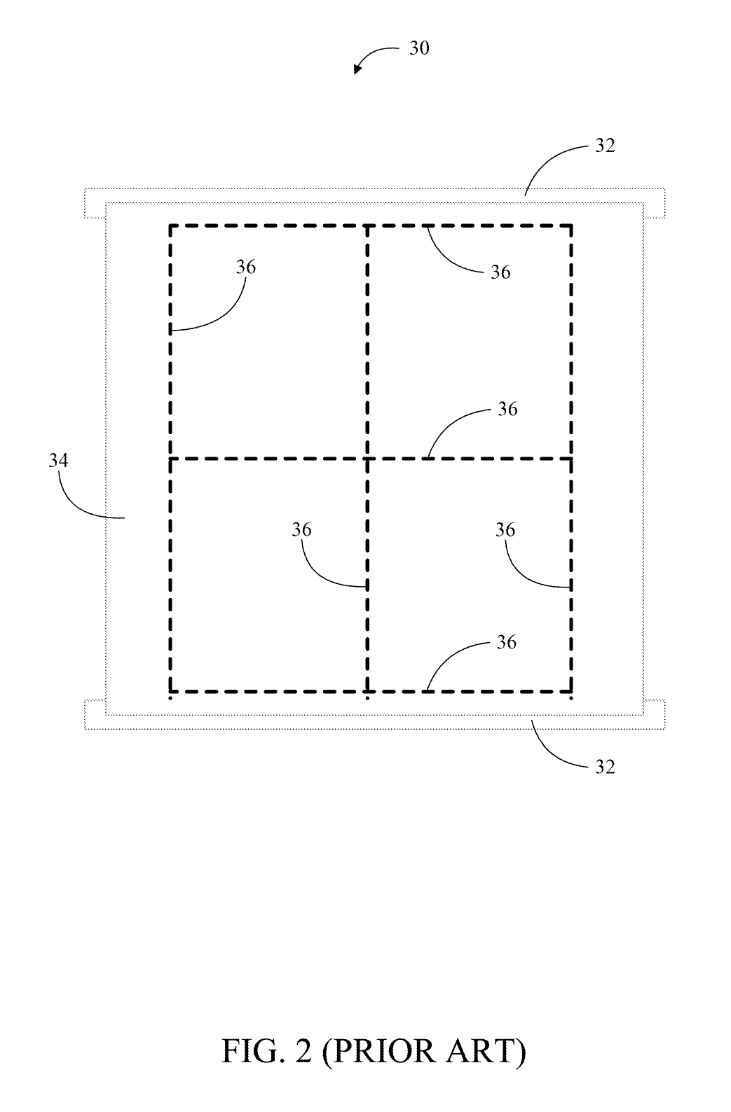

Presently, die-cutting, perforating, cutting or creasing directly on the offset printing press system 10 is facilitated using an IOD (inline offset die-cutting) perf plate 30 (refer to FIG. 2). The perf plate 30 is produced using a desktop publishing application 54 file such as *.pdf, *.ai, *.cdr, *.dxf or any graphic file known in the art that is transformed into a die file. The IOD (inline offset die-cutting) perf plate 30 is chemically etched and machined to produce a flexible die 34 with perf rule 36 and mounting bars 32 specific to each printing job. The benefits of using an IOD (inline offset die-cutting) perf plate 30 are printing, perforating, cutting or creasing in a single operation, reduced delivery periods , printing, perforating, cutting or creasing at normal press speeds, repeated use and optimum flat sheet alignment after finishing.

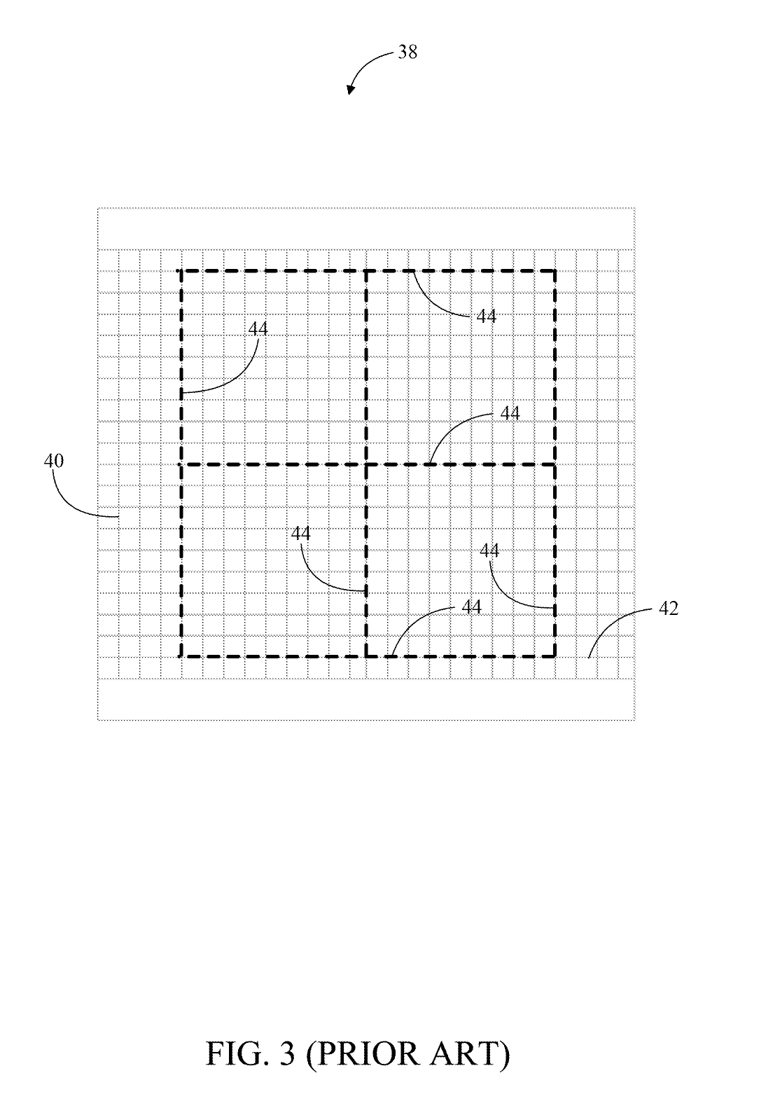

Another method presently used for perforating, cutting or creasing in a single operation involves securing perf rule 44 to a carrier sheet 38 (refer to FIG. 3). A copy of the print job is laid beneath the carrier sheet 38 to assist with aligning the perf rule 44. The carrier sheet 38 is then secured to the blanket cylinder 26 by spray adhesive or other similar adhesive material.

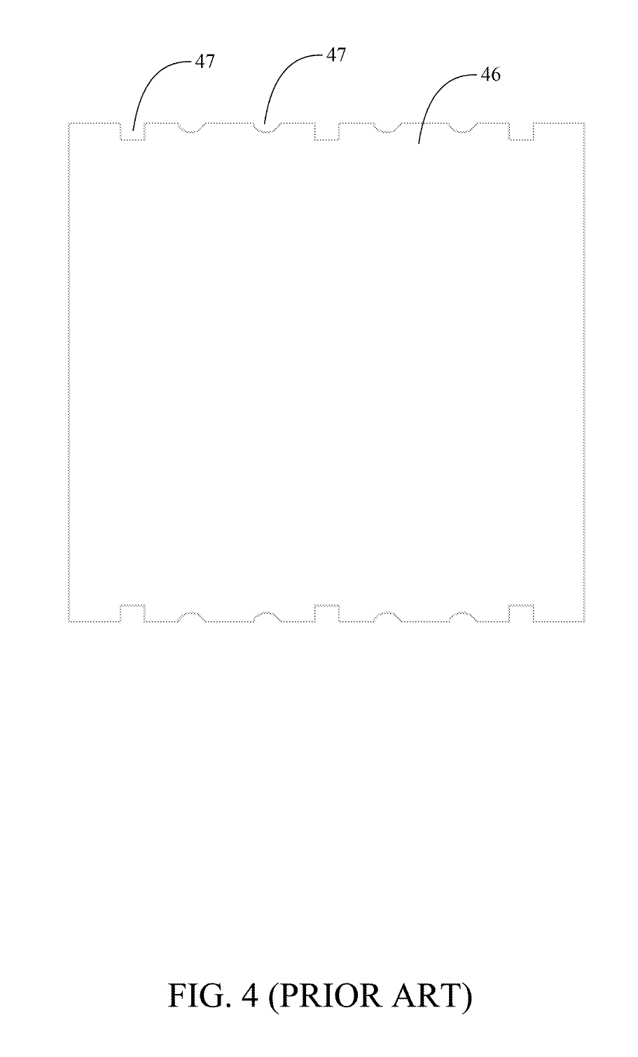

FIG. 4 shows a standard printing plate 46 used on the offset printing press system 10. The printing plate 46 has rectangular and/or arcuate notches 47 that help secure the printing plate 46 to the blanket cylinder 26. Computer-to-plate (CTP) is a newer technology that allows the imaging of metal or polyester plates without the use of film. Eliminating the stripping, compositing, and traditional plate making processes, CTP revolutionized the printing industry and led to reduced prepress times, lower costs of labor, and improved print quality. With this technology, an image created in a Desktop Publishing (DTP) application 54 is output directly to a printing plate by a printer equipped to perform this task. A separate printing plate 46 is required for each separate color needed to produce the desired image.

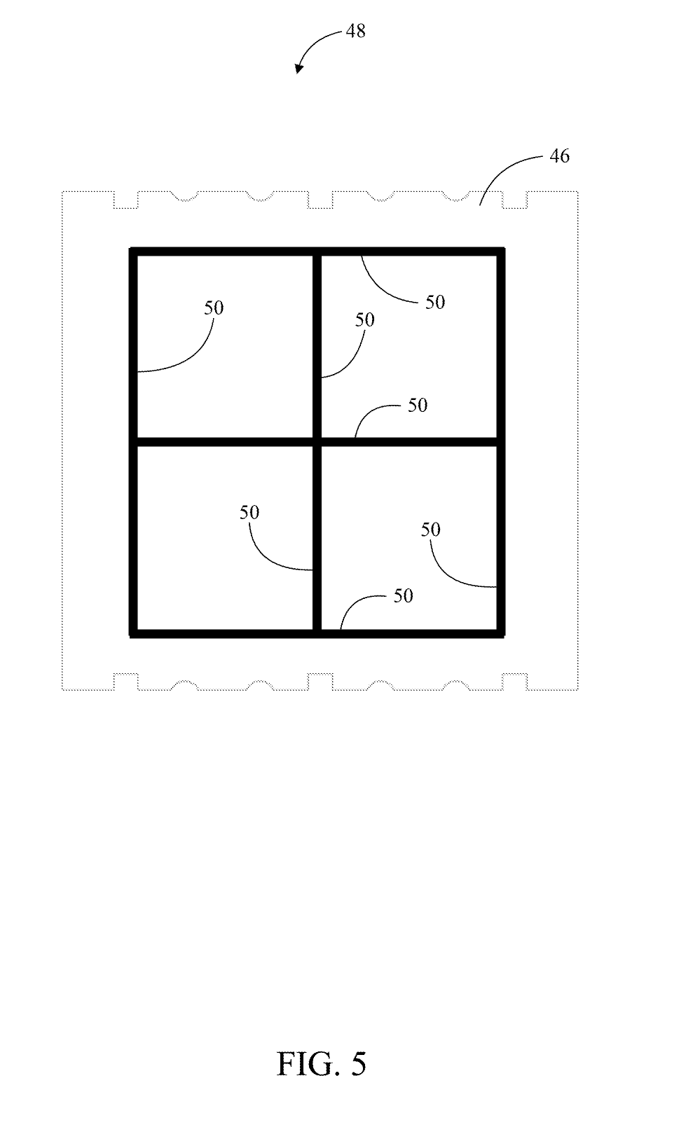

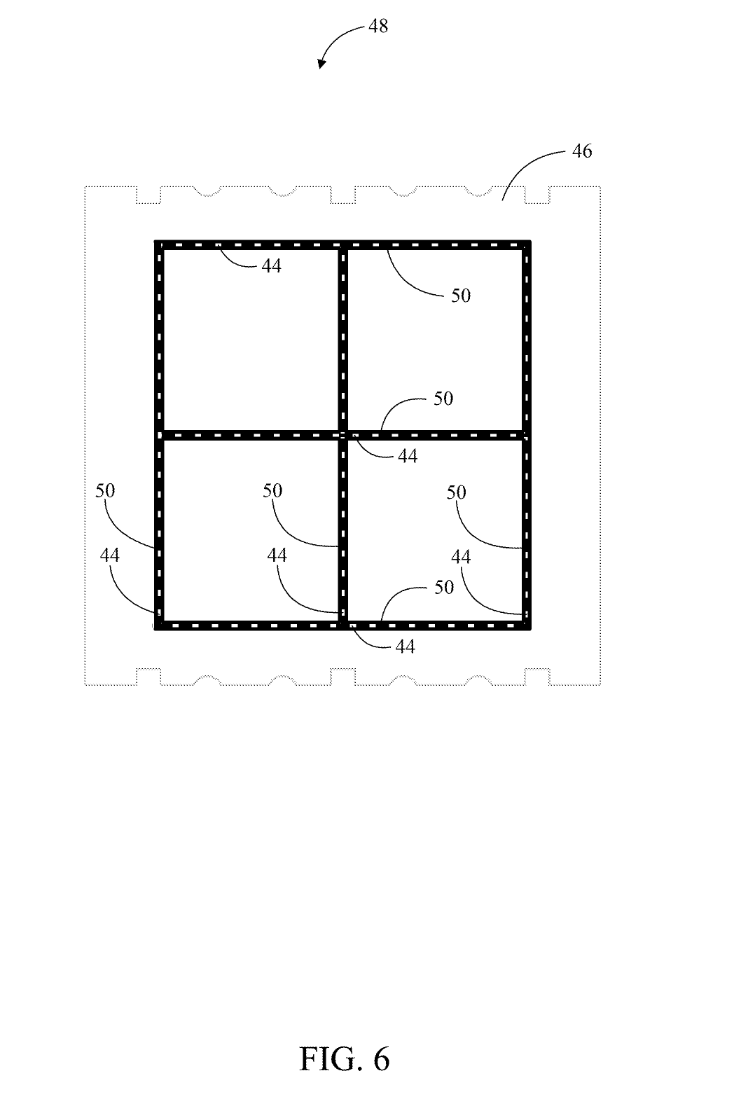

The preferred embodiment utilizes a standard printing plate 46 to create a perf plate 48. As with the creation of a printing plate 46, the location for the perf rule 44 is imaged onto the printing plate 46 and visible guidelines 50, as shown in FIG. 5. The perf rule 44 can now be placed within the perf rule guidelines 50, refer to FIG. 6.

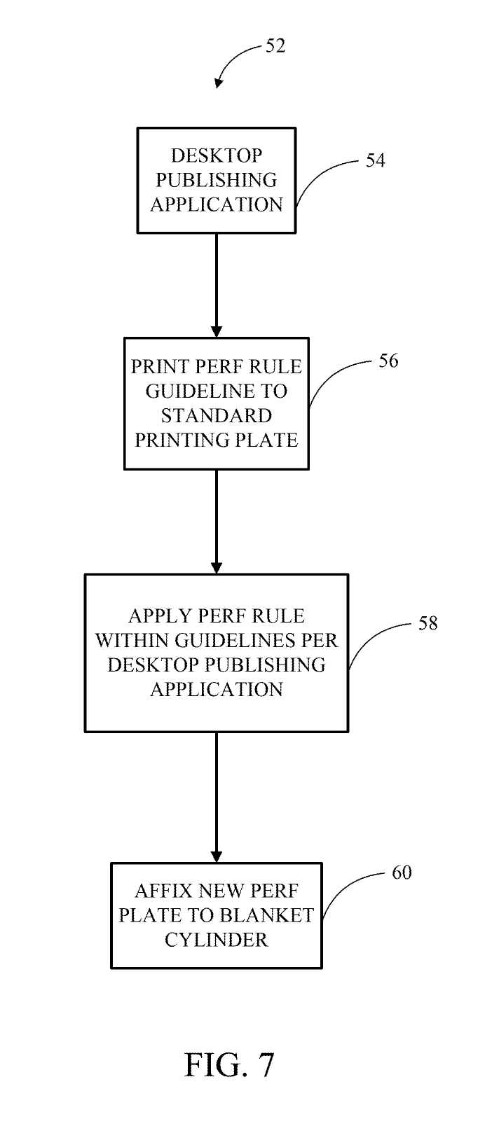

FIG. 7 illustrates the method of the preferred embodiment. The improved perf plate method 52 requires an image to be created with a desktop publishing application 54. The desktop publishing application 54 produces an output file which is utilized by a printer 56 to image the perf rule guidelines 50 onto the standard printing plate 46. The perf rule 44 is then applied 58 within the perf rule guidelines 50. The improved perf plate 48 is now finished and ready to be affixed 60 to a combination plate and blanket cylinder 26 of the coating station 20 of the printing press system 10.

### EXAMPLE 1

An example of the process of preparing a perf plate for producing perforations in a sheet of paper in an offset printing press will now be described in more detail. While the specific steps and equipment are mentioned, it is contemplated that any such equipment for performing the steps is part of the present invention. Before any steps in the pressroom, the follow steps occur to create a printing plate having perf guidelines to attach the perf rules to:
1. Prepress will have to determine the shrink factor depending on the size of the back cylinder.
2. An example is 99.5% shrink applied to the form so the perforations will be in the correct place farther back on the sheet in the horizontal position. This may take a try or two to get it exact or within the desired tolerances.
3. KBA In-Line Perforation Plate Procedure using the TPI Perforating System
   a) Go to the Sig file in Rampage (or similar press software) and output Sig with tools (export with Die-Line Options)
   b) Take PS File to Illustrator (desktop publishing application, available from www.adobe.com) and set the file to match the sheet size plus 0.9063.
      a. Example: (28×40 will be 28.9063×40)
   c) Move all content to the tail of the new sheet size, leaving the 0.9063 space as extra set-back at the gripper.
   d) Select all perforation lines. Make all perforation lines solid and set them to 5 pt. or 7 pt. depending on what brand of perforation rule you use.
   e) Save as Illustrator.eps file. (level3)
   f) Save again as Illustrator.pdf file (the image) with no crops, no bleeds, and hi resolution.
   g) Open PDF in Acrobat and rotate 90 degrees clockwise.
   h) Rip in Rampage (or similar software) using Master Litho Perforation Save Profile. This file will automatically rip the file with no marks, bleeds, slug lines and set to composite output.
   i) After ripping, the file is ready to plate. Select the Screen Platerite 8800 and KBA option. Under Black Channel , go to the H SCALE Colum, type in 99.275% (this is a 1/32 correction)
   j) Output Plate.
4. The perforation files will be made with a 5 point or 7 point rule to lay the perforation rule over for an exacting fit to the form. These files will be sent to your output device and a plate will be made for the pinned aqueous coater of a KBA in this case (printing the perf rule guidelines on the printing plate according to the image).

After the perf guidelines are printed onto a standard printing plate, the perf rules can be applied to the plate to complete the perf plate. To aid in these steps, additional supplies may be useful. For instance, a rule cutter will aid in cutting many pieces of perf rule the same size quickly. An optivisor (5× or smaller) will give clear magnification for the perf rule that needs ground out and to cut miters for corners in the form. A high speed engraving tool such as a Presto turbo grinder available from NSK America, 700 B Cooper Court, Schaumburg, Ill. 60173, having 1/16 inch burrs may be used for precision work. Finally, it is beneficial to have a well-lighted area with a work bench and a light table or solid table. To attach the perf rules to the printing plate, the following steps may be completed:
1. The average time to attach or apply the perf rules to the printing plate is two hours. However, some forms will take up to four hours depending on the amount of perforating rule applied to the plate.
2. Figuring out which way to lay out the plate takes a little forethought. You want to figure the best way with the least amount of grinding and the fewest pieces of perforating rule to use. However, this takes little time to adjust to with any mechanical skill.
3. The perforating rule is measured and the pieces that need ground are taped to the plate so the perforations almost touch for the cleanest tear. The areas that need ground are marked with a whiteout pen. All pieces need to be cut and laid on the plate to confirm all pieces have been cut for a form.

Once all the steps of the example have been completed, the perf plate has been prepared and is ready to attach to an impression plate. However, it should be noted that the example given is merely an exemplary method to complete the process of making the perf plate, and that any number of variations or steps are included within the scope of the present invention. For example, different programs, machines, and tools may be used, and different methods may be used to attach the perf rules to the plates.

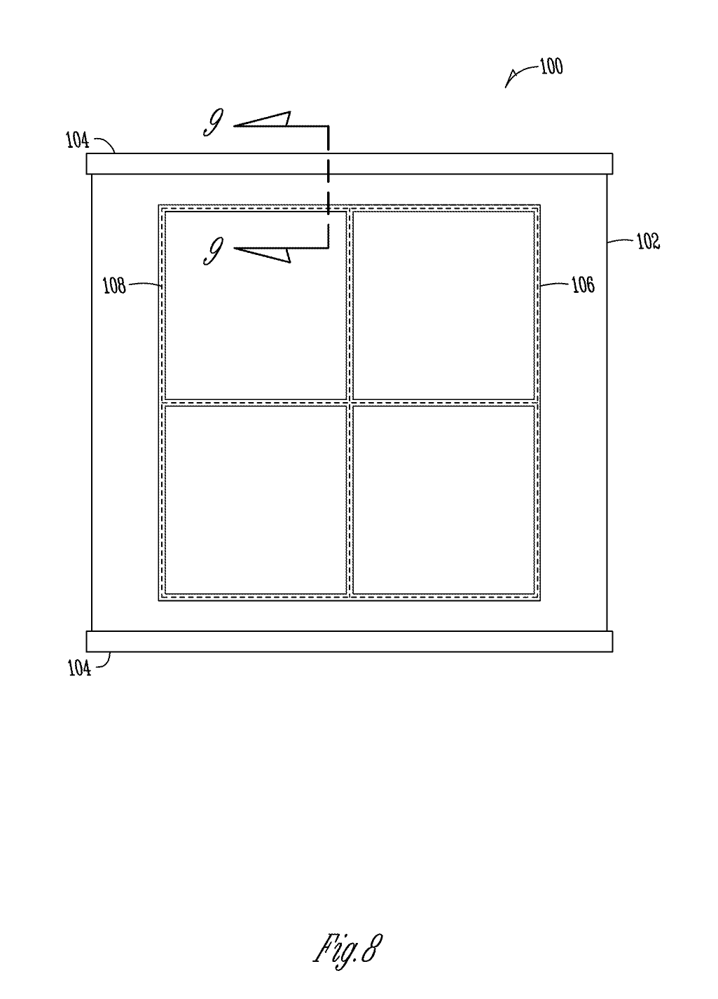

FIGS. 8-10 show another embodiment of the present invention that is a method for producing perfjackets 100 used with offset printing presses, which are more commonly used in the printing industry than presses utilizing the plates 46 discussed above. The perf jackets 100 will comprise a plate 102 and plate bars 104 on opposite ends of the plate that allow the jacket 100 to be attached to a blanket cylinder 24 of a printing station 18 of a printing press system 10. It should be appreciated, however, that the perfjacket 100 can be attached to the blanket cylinder of any of the printing stations 12, 14, 16, or 18.

The plate 102 of the perf jacket 100 of the present invention generally comprises aluminum. A preferred size of the plate 102 is 35.5 inches in length by 40.5 inches in width. The wider plate is more desirable than the standard width of jackets because currently, two jackets must be used together to provide the same or approximately the same width as a plate. It can be extremely difficult to make sure that the two jackets are perfectly aligned to produce the desired perforation or crease in the printed material. Having only one plate also decreases the cost of the jacket. However, it should be appreciated that the plate 102 used in the perf jacket 100 may be the same plate as the standard printing plate 46 discussed above. The main difference will be that the plate 102 used with the perfjacket 100 will not have the notches or cutouts along the edges of the plate, and instead will be a generally straight-edged rectangular piece of material.

The first step of producing the perfjacket 100 is to print guidelines 106 on the plate 102. The guidelines 106 are printed on the plate 102 using the same method as described above. Namely, an image is created using a desktop publishing program or application. The image is a collection of guidelines to lay out exactly where the perf rules will be positioned on the plate 102. An output file of the image is then sent to a printer, which “prints” the image or guidelines 106 onto the plate 102. Once the guidelines 106 have been printed onto the plate 102, the desired perf rule 108 is added to the plate. The location of the perf rule 108 is designated by the guidelines 106. For instance, the perf rule 108 should preferably be affixed to the plate directly in the center of the guidelines 106. The perf rules 108 are attached to and affixed to the plate 102 in the same manner as was described above regarding FIG. 6 and in the Example.

Finally, the plate bars 104 are attached and affixed to opposite ends of the plate 102. The plate bars 104 may be standard bars used with blanket cylinders that allow the bars to attach to the cylinders. In addition, while different brands of presses use different sizes and shapes of bars, it should be appreciated that the present invention is to be considered universal in that any particular bar used with any particular press may be added to the perf plate 102 to produce the perf jacket 100 of the present invention. While generally printing press bars are made of a metal, such as aluminum, it should be appreciated that any other rigid material may be used to make the bars. The bars need only be strong enough to be affixed to the plates and to not break when in use with the press. However, it is preferred that the bars have a width of ⅝ inches, and a length of 41 inches. Therefore, the bars will be approximately 0.5 inches longer than the width of the plate 102, which allows the bars to extend on each side by approximately 0.25 inches.

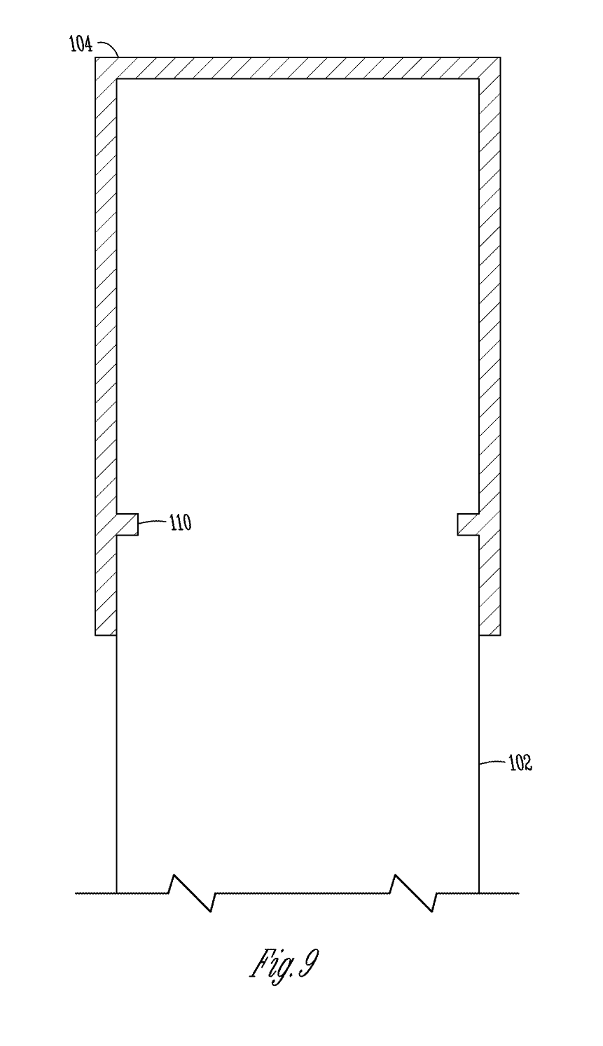

The bars 104 may be attached or affixed to the perf plate 102 in many different ways. For instance, as shown best in FIG. 9, the bars are generally U-shaped and surround an end of the plate 102. An adhesive may be placed about the inside of the bar, the bar placed over the end of the plate, and then a crimping device may be used to secure the plate in the bar. The addition of ridges 110 in the bars will further ensure that the bars 104 will stay attached to and affixed to the plates 102 as the ridge 110 may create an indent in the plate material to prevent the bar from becoming detached from the plate.

The bars 104 may be attached to the plate 102 in any number of ways, however. For instance, the bars may be attached to the plate by high frequency welding, spot welding, strong adhesives such as a glue or epoxy, screws or bolts, rivet and rivet gun, friction fit, tape, staples, arc welding, solid-state welding, gas welding, resistance welding, or any other manner that will keep the bars 104 affixed to the plate 102. Once the bars 104 have been attached to the plate 102, the resulting perfjacket 100 may be attached to a blanket cylinder 24 of a printing press system to create the desired perforations or creases. By producing the perfjackets in the manner described and shown in FIGS. 8-10, a company would be able to save considerable time and money. The costs of plates 102 and bars 104 are considerably less than the costs of having a third party manufacture the jackets, while the production time may be lessened from 4-5 days to a couple hours.

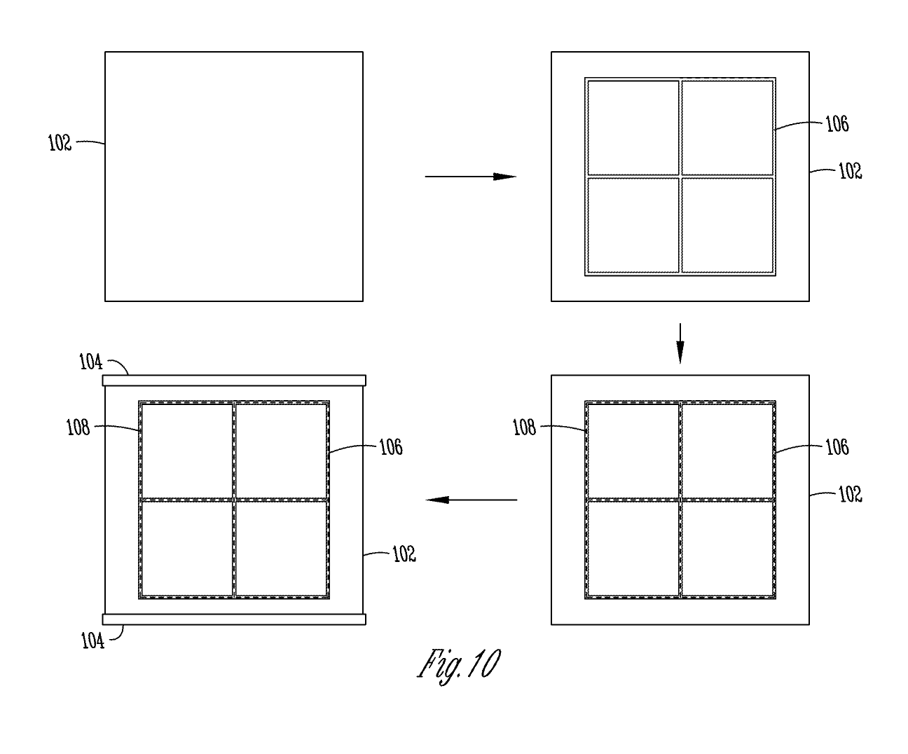

FIG. 10 is a flow chart showing a method of producing the perfjacket 100 of the present invention. As shown in the chart, a plate 102 is first provided. The next step shows that guidelines 106 have been printed onto the plate 102 according to an image, which was produced by a desktop publishing application. Next, perf rule 108 is applied to and affixed to the plate 102 according to the guidelines 106. The perf rule 108 generally includes an adhesive on one side, but may also be reinforced with a tape or other adhesive to further aid in affixing the perf rule 108 to the plate 102. Finally, bars 104 are attached to the perf plate on opposite sides of the plate. The bars may be attached in the manner described above. Once the bars 104 have been attached, a perf jacket 100 has been created. The perfjacket 100 can then be attached to a blanket cylinder 24 of a printing station 18 of a printing press 10 to create perforations or creases in printed material.

### EXAMPLE 2

An example of the process of preparing a perfjacket for producing perforations in a sheet of paper in an offset printing press will now be described in more detail. While the specific steps and equipment are mentioned, it is contemplated that any such equipment for performing the steps is part of the present invention.
1. Start with a plate being approximately 35.5 inches in length by 40.5 inches in width.
2. Prepare the perf plate by completing the steps listed in Example 1 above.
3. Using plate bars measuring ⅝ inches wide and 41 inches long, attach the bars to the perf plate with a crimping device and an adhesive to form the perfjackets.
4. New positioning relative to the amount of the plate to be wound into the blanket cylinder clamps will need to be achieved to properly set back and image positioning to the printed work.
5. Attach the perf jackets to the blanket cylinder.

The invention has been shown and described above with the preferred embodiments, and it is understood that many modifications, substitutions, and additions may be made which are within the intended spirit and scope of the invention. The present invention is not to be limited to any specific embodiment described herein.

What is claimed is:

1. A method of making a perf plate for producing perforations in a sheet of paper in an offset printing press, comprising:
creating an image;
printing at least one perf rule guideline on a printing plate according to said image; and
applying a perf rule onto the at least one perf rule guideline.

2. The method of claim 1 wherein the image is created using a desktop publishing application.

3. The method of claim 1 further comprising affixing the perf rule onto the at least one perf rule guideline.

4. The method of claim 1 further comprising applying a layer of tape over the perf rule to hold the perf rule in place.

5. The method of claim 1 further comprising adding additional perf rules to the printing plate to match the image.

6. The method of claim 1 further comprising selecting a perf rule according to the desired style of a perforation in the sheet of paper.

7. A perf plate for use with an offset printing press, comprising:
a printing plate, said printing plate including at least one guideline printed thereon according to an image produced by a desktop publishing application; and
a perf rule affixed to the at least one guideline according to the image.

8. The perf plate of claim 7 wherein the printing plate comprises notches to aid in attaching the printing plate to a blanket cylinder.

9. The perf plate of claim 8 wherein the notches are arcuate-shaped.

10. The perf plate of claim 8 wherein the notches are rectangular-shaped.

11. The perf plate of claim 8 wherein the notches are both arcuate and rectangular shaped.

12. The perf plate of claim 7 wherein the printing plate comprises aluminum.

13. The perf plate of claim 7 further comprising a layer of tape on top of the perf rule to further affix the perf rule to the printing plate.

14. The perf plate of claim 7 wherein the guidelines are formed by computer-to-plate technology.

15. A method of perforating a sheet of paper in an offset printing press, comprising:
producing a perf plate by creating an image in a desktop publishing application, printing the image onto a printing plate to create perf guidelines, and applying at least one perf rule to the perf guidelines;
operably attaching the perf plate to a combination plate and blanket cylinder in line of an offset printing press; and
passing a sheet of paper through the offset printing press such that the perf plate contacts the sheet of paper to produce perforations therein.

16. The method of claim 15 further comprising reviewing the sheet of paper to ensure that the perforations are in the correct position.

17. The method of claim 16 further comprising adjusting the blanket cylinder containing the perf plate according the correct position.

18. The method of claim 15 wherein the step of producing the perf plate further comprises applying tape on top of the perf rule to further affix the perf rule to the printing plate.

19. The method of claim 15 wherein the step of producing the perf plate further comprises selecting the perf rule according to the desired perforation through the sheet of paper.

20. A method of producing a perfjacket for producing perforations in a sheet of paper in an offset printing process, comprising:
creating an image;
printing at least one perf rule guideline on a printing plate according to said image;
applying a perf rule onto the at least one perf rule guideline; and
attaching plate bars to opposite ends of the printing plate, the plate bars configured to operatively attach to a blanket cylinder of a printing station of a printing press.

21. The method of claim 20 wherein the step of attaching plate bars to opposite ends of the printing plate includes crimping opposite sides of the bars together about and end of the plate.

22. The method of claim 20 further comprising applying an adhesive to the inside of the plate bars before attaching the plate bars to the printing plate.
